(19) United States
(12) Patent Application Publication
(10) Pub. No.: US 2007/0027841 A1
(43) Pub. Date: Feb. 1, 2007

(54) Messaging middleware dynamic, continuous search and response agent system

(76) Inventor: Michael G. Williams, Newbury Park, CA (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/190,502

(22) Filed: Jul. 26, 2005

(51) Int. Cl. G06F 17/30

(52) U.S. Cl. 707/3

(57) ABSTRACT

A method and apparatus are provided for searching for information on an Intranet or other suitable private network implemented in a corporation or other business entity or organization, featuring at least one agent in the Intranet that scans email, messaging and/or Intranet resources and provides information in response to a search request from a requesting node. In operation, one or more agents scans the dynamic flow of messaging for search terms and level of authority and issues queries on behalf of the requesting node in order to regulate the secrecy and privacy of the information on the Intranet. In effect, the present invention provides a set of software agents that scan email, messaging or intranet resources during transmission and after storage on the Intranet. These agents issue queries on behalf of verified, authenticated and/or authorised individuals, to messaging accounts related to those messages or documents. These agents also respond to queries from agents in the automatic mode, on behalf of verified, authorised responders. In manual mode, these agents verify the responder's identity and authorisation upon response.

### BACKGROUND OF THE INVENTION

1. Technical Field

The present invention generally relates to a method and apparatus for searching a network; and more particularly to a method and apparatus for searching an Intranet that forms part of a network in a corporation or other suitable entity or organization.

2. Description of Related Problem

Corporations run their business over email and messaging between employees. The larger the corporation, the more email and distribution lists, buddy lists, groups, chat facilities etc grows. Corporations try to create a central search engine that searches their Intranet to create a resource for employees to search throughout the corporation for information, other people working on the same thing as them, etc. This system involves a manual process of each employee running searches to try and find matches that might be interesting. The skill of the employee at using the search tool, affects the degree of success. Also, many internal websites, blogs or workspaces are restricted to people outside the group.

Email and messaging is often sent between groups or individuals occupied with a particular subject, and others outside them will not have access to this communication. Even if the individuals archive their email, or groups archive their email (and other forms of messaging) search engines often do not have access to those archives for privacy reasons.

Search engine services are offered by search engine companies as a corporate service for creating databases about corporate Intranets, e.g. Akamai, Google, etc. Google has the “Google alert” feature that sends email to a requester when the search engine crosses a web page with matching terms. Moreover, online retailers have the “notify me when . . . ” feature on their websites which lets users register interest in a particular event.

### SUMMARY OF THE INVENTION

In its broadest sense, the present invention provides a new and unique method and apparatus for searching for information on an Intranet or other suitable network implemented in a corporation or other business entity or organization, featuring at least one agent in the Intranet that scans email, messaging and/or Intranet resources and provides information in response to a search request from a requesting node. In operation, the one or more agents scan the dynamic flow of messaging for search terms and level of authority and issues queries on behalf of the requesting node in order to regulate the secrecy and privacy of the information on the Intranet.

In effect, the present invention provides a set of software agents that scan email, messaging or intranet resources during transmission and after storage on the Intranet. These agents issue queries on behalf of verified, authenticated and/or authorised individuals, to messaging accounts related to those messages or documents. These agents also respond to queries from agents in the automatic mode, on behalf of verified, authorised responders. In manual mode, these agents verify the responder's identity and authorisation upon response.

A possible use case would be that the mobile/push email portal that is in the stream of email processing on the Intranet could run the agent with an instance/profile for each registered user. If a registered user, e.g. Pekka, is looking for all people or groups working on 3GPP standardization, Pekka could command his or her agent to search for that. The agent would verify Pekka's identity when accepting the query, and optionally check Pekka's authorisation for this. Another part of the agent system would scan email and messaging as well as Intranet file servers from that point on, looking for matches to Pekka's search terms and level of authorisation. When an email or message or document contains a match the agent would follow policy to determine the appropriate individuals/groups, and if Pekka was authorised, inform the recipient of Pekka's search via a message.

The email or message from Pekka's agent could be responded to by the recipient's agent or by the recipient directly. The nature of the recipient's response determines what Pekka receives from his agent. If the query touches on private or secret projects or information, the recipient/group may choose a response that preserves that status. If the query touches on a timely topic, Pekka may receive a response directly from the recipient or his/her agent. The recipient's identity and authorisation would be checked upon they or their agent responding. As an option, the agents may return rankings of matched responses. Another option would permit query updates by Pekka or his agent.

The ideal implementation would be where a machine or series of machines act as the messaging and email conduit for all Intranet messaging. Additionally, file servers that house websites and other intranet storage could also run the agents. All these machines would support the hosting of the middleware agents. This reduces Intranet traffic, rather than hosting the agents on a separate machine that must be in the stream of traffic or be able to remotely scan file stores. It also increases security, as the queries can be done locally (not over the network), and only the responses need securing.

The users would securely register with the agents so the agents can identify and trust future queries and response instructions by the users. The interaction with the agents would be at a level where a mobile device could easily create a query and receive a response.

Agents would create the appearance of a single agent to the registered user, while there might really be multiple agents running on separate systems or networks within the corporation, distributing the query automatically for the registered user. The separate agents would coordinate to perform the registered user's service. Registered users could create defined responses for particular topics so their response agents can return information directly to those looking, without manual response.

According to the present invention, the apparatus may take the form of one or more agents having a module for scanning the email, messaging and/or Intranet resources and providing the information in response to the search request from the requesting node, as well as an Intranet or other suitable network implemented in a corporation or other business entity or organization featuring such an agent for scanning the email, messaging and/or Intranet resources consistent with that described herein.

The present invention may also take the form of a computer program product with a program code, which program code is stored on a machine readable carrier, for carrying out the steps of a method comprising the steps of: scanning email, messaging and/or Intranet resources and providing information in respond to a search request from a requesting node, when the computer program is run in a processor or control module of either user equipment, a network node, or some combination thereof, consistent with that described herein.

One advantage of the present invention is that it improves the ability for employees to locate individuals that are dealing with a subject while enabling the preservation of privacy of messaging. By scanning the dynamic flow of messaging for search terms and issuing queries on behalf of the searcher, the agent interposes a service which can be regulated for controlling secrecy/privacy. The individuals contacted by the agent can manually or automatically respond in ways that facilitate personal connections while also enabling the preservation of privacy/secrecy. By interposing a service between the searcher and the rest of the corporation, the identity of the searcher, and the identity of the responder(s) can be verified to establish trust.

Moreover, this invention gives dynamic access on an ongoing basis (continuous search, not just one time search.) This invention lets all information be searched without having to make the information available publicly. The owners of the information retain control over who will be notified about it. Both the searcher and the owner of the information have their identities verified, and authorization checked. This invention lets people find out about others dealing with subjects within the corporation in a manual or fully automated way, reducing the burden for finding and establishing contacts.

The foregoing and other objects, features and advantages of the present invention will become more apparent in light of the following detailed description of exemplary embodiments thereof.

### BRIEF DESCRIPTION OF THE DRAWING

The drawing is not drawn to scale and includes the following Figures:

FIG. 1 show a basic diagram of an Intranet according to the present invention.

FIG. 2 show a block diagram of an agent shown in FIG. 1 according to the present invention.

### BEST MODE FOR CARRYING OUT THE INVENTION

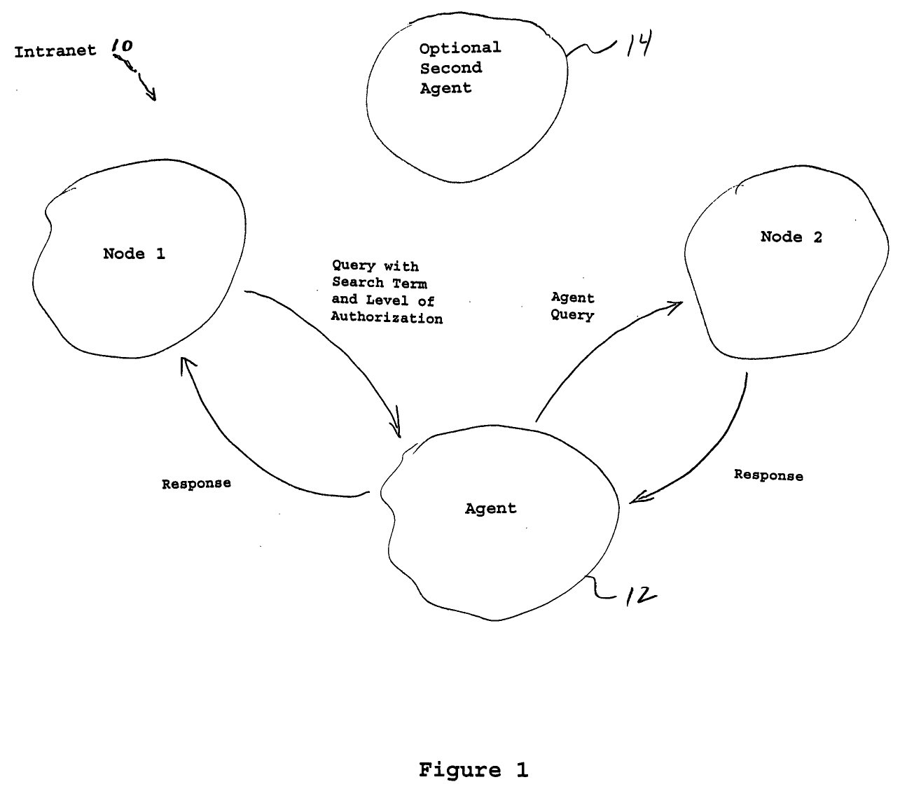

FIG. 1 shows the basic invention, by way of example, in the form of an Intranet or other suitable private network to be implemented in a corporation or other business entity or organization generally indicated as 10 featuring at least one agent 12, 14 for scanning email, messaging and/or Intranet resources and providing information in response to a search request or query from a requesting node such as node 1 as shown. In operation, the one or more agents 12, 14 scans the dynamic flow of messaging for search terms and level of authority and issues queries on behalf of a requesting node, such as node 1, in order to regulate the secrecy and privacy of the information on the Intranet 10.

The present invention is described by way of example in relation to the Intranet, which is understood by a person skilled in the art to be a private network that uses Internet software and Internet standards and is reserved for use by people who have been given authority and/or password(s) to use the same. See Newton's Telecom Dictionary, 16th Edition, page 470. Corporations and other business entities or organizations are increasingly using Intranets—internal web servers—to give their employees easy access to corporate information. However, the scope of the invention is not intended to be limited to this type of private network, or the type of kind of software or standards used in the private network. In other words, the scope of the invention is intended to include other suitable private networks either now known or later developed in the future using other types of software and standards either now known or later developed in the future.

In operation, the agent 12 may scan the email, messaging and/or Intranet resources during transmission of the same in the Intranet 10, after storage of the same on the Intranet 10, for example, in a second node 2, as shown, or some combination thereof. The scope of the invention is not intended to be limited to when or where the agent 12 scans the email, messaging and/or Intranet resources in the Internet 10.

The requesting node 1 may take the form of any suitable terminal, user equipment, mobile terminal or other device forming part of an Intranet or other suitable network, or other device joining the Intranet or other suitable network, either now known in the art or later developed in the future. In other words, the scope of the invention is not intended to be limited to any particular type or kind of requesting node.

As shown in FIG. 1, the requesting node 1 may provide a query to the agent 12. The query may contain a search term and level of authorization, although the scope of the invention is not intended to be limited to the type or kind of information contained in the query. The agent 12 may verified, authenticated and/or authorised the requesting node 1 using techniques either now known in the art or later developed in the future. The scope of the invention is not intended to be limited to the type or kind of techniques for verify, authenticating and/or authorising of the requesting node 1. The agent 12 may then issue one or more queries on behalf of verified, authenticated and/or authorised requesting node 1, to messaging accounts related to those messages or documents. As shown, the one or more queries are issued to the node 2, which may take the form of email, messaging and/or Intranet resources either now known in the art or later developed in the future, including a file server or the like that are known in the art, which may, for example, house one or more websites and other Intranet storage. The node 2 may provide a response back to the agent 12 with information in response to the search request or query.

The scope of the invention is not intended to be limited to the agent 12 issuing a query to only node 2 in response to a respective query from the requesting node 1. For example, the agent 12 may issue a query to a second agent 14, as shown, or to both node 2 and the second agent 14, or the other nodes not shown in FIG. 1. The scope of the invention is not intended to be limited to the type, kind or number of node or nodes queried by the agent 12. Alternatively, the agent 12 may respond to the query from the requesting node 1 with information previously gathered and stored by the agent 12, without querying any other node or nodes in the Intranet 10.

Moreover, the scope of the invention is not intended to be limited to the agent 12 being a separate node in the Intranet 10 as shown. Embodiments are envisioned wherein the agents forms part of a machine or series of machines that act as the messaging and email conduit for all Intranet messaging. Additionally, file servers that house websites like node 2 in FIG. 1 and other intranet storage could also run one or more of the agents 12 and/or 14. All these machines or nodes could support the hosting of middleware agents like agents 12, 14, which reduces Intranet traffic, rather than hosting the agents on a separate machine that must be in the stream of traffic or be able to remotely scan file stores. It also increases security, as the queries can be done locally (not over the network), and only the responses need securing.

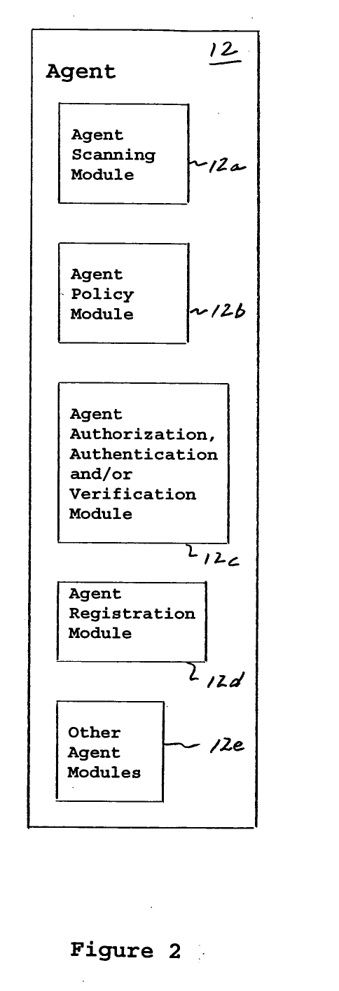

### FIG. 2: the Agent 12, 14

FIG. 2 shows, by way of example, a block diagram of the agent 12 or 14 having an agent scanning module 12a, an agent policy module 12b, an agent authorization, authentication and/or verification module 12c, an agent registration module 12d and other agent modules 12e.

The agent scanning module 12a may be implemented to scan the email, messaging and/or intranet resources during transmission of the same in the Intranet 10, after storage of the same on the Intranet 10, for example, in a second node 2, as shown, or some combination thereof. Consistent with that discussed above, the scanning and the processing of the information resulting from the scanning may be performed in response to a query from the requesting node 1 or at some other suitable time.

The agent policy module 12b may be implemented to determine the appropriate individuals, groups or nodes that may received different types or kinds of information. For example, when an email or message or document contains a match the agent 12 would follow policy to determine the appropriate individuals/groups, and if a requesting node was authorised, inform the recipient of requesting node's search via a message.

The agent authorization, authentication and/or verification module 12c may be implemented to authorise, authenticate and/or verify users, nodes or the like making a search request and/or receiving information resulting from such a search request. The scope of the invention is not intended to be limited to any particular type or kind of authorization, authentication and/or verification processes of users, nodes or the like either now known in the art or later developed in the future.

The agent registration module 12d would securely register users with the agent or agents 12, 14 so the agents can identify and trust future queries and response instructions by the users, as well as perform other functionality related to such a registration either now known or later developed in the future. The scope of the invention is not intended to be limited to any particular type or kind of registration process of users, nodes or the like.

By way of example, the functionality of one or more of the modules 12a, 12b, 12c and/or 12d shown in FIG. 2 may be implemented using hardware, software, firmware, or a combination thereof, although the scope of the invention is not intended to be limited to any particular embodiment thereof. In a typical software implementation, such a module would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology known or later developed in the future. Moreover, the scope of the invention is intended to include the one or more modules shown in FIG. 2 being stand alone modules for implementing their respective functionality, as well as one module for implementing the functionality of the modules in the combination, or in combination with other circuitry for implementing the same.

The other agent module 12e and the functionality thereof are known in the art, do not form part of the underlying invention per se, and are not described in detail herein. For example, the other modules 12e may include other modules for performing functionality such as input/output, data and control processing, keyboard, etc., which are known in the art and not described herein.

### THE SCOPE OF THE INVENTION

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein and thereto without departing from the spirit and scope of the present invention.

What is claimed is:

1. An agent for searching for information on an Intranet or other suitable private network implemented in a corporation or other business entity or organization, the agent comprising:
a module for scanning email, messaging and/or Intranet resources and providing information in response to a search request from a requesting node.

2. An agent according to claim 1, wherein the module scans the dynamic flow of messaging for search terms and level of authority and issues queries on behalf of the requesting node in order to regulate the secrecy and privacy of the information on the Intranet.

3. An agent according to claim 1, wherein the agent is a software agent that performs some information gathering or processing task in the background.

4. An agent according to claim 1, wherein the module scans the email, messaging and Intranet resources during transmission, after storage on the Intranet, or some combination thereof.

5. An agent according to claim 1, wherein the module verifies the identity of the requesting node and/or the authority of the requesting node to receive the information.

6. An agent according to claim 1, wherein the module authenticates the identity of the requesting node.

7. An agent according to claim 1, wherein the Intranet resources include one or more file servers.

8. An agent according to claim 1, wherein the agent forms part of one or more machines that act as the messaging and email conduit for all Intranet messaging.

9. An agent according to claim 1, wherein the agent forms part of one or more of the Intranet resources, including one or more file servers that house one or more websites.

10. An agent according to claim 1, wherein the agent forms part of a separate machine in the stream of traffic.

11. An agent according to claim 1, wherein the module issues one or more queries on behalf of verified, authenticated and/or authorized requesting node.

12. An agent according to claim 1, wherein, when in an automatic mode, the module responds to one or more queries from one or more other agents on behalf of verified, authenticated and/or authorized responders.

13. An agent according to claim 1, wherein, when in a manual mode, the module verifies a responder's identity and authorization upon response.

14. An agent according to claim 1, wherein, when finding a match, the module follow a policy to determine appropriate individuals/groups, and if the requesting node is authorized, informs a recipient of the search request via a message.

15. An agent according to claim 14, wherein the requesting node receives the information based on the response from the recipient or a recipient's agent.

16. An agent according to claim 14, wherein the module checks the recipient's identity and authorization.

17. An agent according to claim 1, wherein the module registers the requesting node so as to identify the same for future search requests.

18. An agent according to claim 1, wherein the requesting node is a mobile terminal that can provide a search request and receive a response.

19. An agent according to claim 1, wherein the agent takes the form of a mobile/push email portal that is in the stream of email processing on an Intranet that runs as such an agent with an instance/profile for each registered user.

20. An agent according to claim 1, wherein the Intranet forms part of a network in a corporation or other suitable entity or organization.

21. A method for searching for information on an Intranet or other suitable private network implemented in a corporation or other business entity or organization, characterized in that
at least one agent in the Intranet scans email, messaging and/or Intranet resources and provides information in response to a search request from a requesting node.

22. A method according to claim 21, wherein the at least one agent scans the dynamic flow of messaging for search terms and level of authority and issues queries on behalf of the requesting node in order to regulate the secrecy and privacy of the information on the Intranet.

23. A method according to claim 21, wherein the at least one agent is a software agent that performs some information gathering or processing task in the background.

24. A method according to claim 21, wherein the at least one agent scans the email, messaging and Intranet resources during transmission, after storage on the Intranet, or some combination thereof.

25. A method according to claim 21, wherein the at least one agent verifies the identity of the requesting node and/or the authority of the requesting node to receive the information.

26. A method according to claim 21, wherein the method further comprises implementing the step of the method via a computer program running in a processor or controller in the at least one agent.

27. An Intranet or other suitable private network implemented in a corporation or other business entity or organization, comprising:
an agent for scanning email, messaging and/or Intranet resources and providing information in response to a search request from a requesting node.

28. An Intranet or other suitable private network according to claim 27, wherein the agent scans the dynamic flow of messaging for search terms and level of authority and issues queries on behalf of the requesting node in order to regulate the secrecy and privacy of the information on the Intranet.

29. An Intranet or other suitable private network according to claim 27, wherein the agent is a software agent that performs some information gathering or processing task in the background.

30. An Intranet or other suitable private network according to claim 27, wherein the agent scans the email, messaging and Intranet resources during transmission, or after storage on the Intranet, or some combination thereof.

31. An Intranet or other suitable private network according to claim 27, wherein the agent verifies the identity of the requesting node and/or the authority of the requesting node to receive the information.

32. A computer program product with a program code, which program code is stored on a machine readable carrier, for carrying out the steps of a method comprising the steps of: scanning email, messaging and/or Intranet resources and providing information in respond to a search request from a requesting node, when the computer program is run in a processor or control module of either user equipment, a network node, or some combination thereof.
